(19) United States
(12) Patent Application Publication
(10) Pub. No.: US 2013/0113383 A1
(43) Pub. Date: May 9, 2013

(54) APPARATUS AND METHODS FOR IMPROVING ILLUMINATION UNIFORMITY

(71) Applicants: Nawar FDHAL, Mississauga (CA); Matthew KYAN, Richmond Hill (CA)

(72) Inventors: Nawar FDHAL, Mississauga (CA); Matthew KYAN, Richmond Hill (CA)

(21) Appl. No.: 13/670,535

(22) Filed: Nov. 7, 2012

Related U.S. Application Data
(60) Provisional application No. 61/556,706, filed on Nov. 7, 2011.

(51) Int. Cl. H05B 37/02; F21V 33/00

(52) U.S. Cl. CPC H05B 37/02; F21V 33/00
USPC 315/152; 362/253

(57) ABSTRACT

Methods for improving illumination uniformity of illuminated areas (14) are disclosed Apparatus, components and systems for carrying out such methods are also disclosed. An exemplary method (600) includes: receiving a luminance map (28) of the illuminated area (14); computing a luminance adjustment map (36) based on the obtained luminance map (28); and further illuminating the illuminated area (14) in accordance with the luminance adjustment map (36).

### CROSS REFERENCE TO RELATED APPLICATION AND CLAIM OF PRIORITY

The present application claims priority to U.S. provisional patent application No. 61/556,706 filed on Nov. 7, 2011, the entire contents of which are hereby incorporated by reference.

### TECHNICAL FIELD

The disclosure relates generally to illumination, and more particularly to improving uniformity of illumination.

### BACKGROUND

Color and density measurements play important roles in the control of color reproduction but generally do not replace a human observer for final assessment of the quality of complex images. Color reflection artwork, photographic transparencies, photographic prints, and photomechanical reproductions, such as on-press and off-press proofs or press sheets, are commonly evaluated by a human observer for their image and color quality or compared critically with one another for fidelity of color matching.

Illuminated viewing environments, commonly known as light booths, are well known in the photographic and graphic arts for transmission or reflectance viewing of color prints, proofs, transparencies and the like. Typically, a light booth comprises a back-plate against which a reflection copy image such as a document or photograph, is placed for viewing and an overhead lighting source, such as incandescent, fluorescent, or ultraviolet lamp, for illuminating the document. Such viewing systems have found wide-spread use for visual color assessment, comparison of color variations, color-matching and soft-proofing.

One shortcoming of conventional light booths is uneven illumination of the back-plate. Such uneven illumination across a reflection copy image can make accurate color assessment of the entire reflection copy image difficult. Also, when two images are compared, different illumination conditions (e.g. luminance) between the two images can make the visual comparison difficult.

Improvement in the illumination of such viewing areas is therefore desirable.

### SUMMARY

The disclosure describes apparatus, components and methods useful in illumination. The apparatus, components and methods may also be useful in improving the illumination uniformity of illuminated viewing areas.

In one aspect, for example, the disclosure describes an apparatus for viewing a hard copy. The apparatus may comprise: a viewing area for receiving the hard copy; a light source configured to illuminate the viewing area in accordance with a luminance adjustment map, the luminance adjustment map being based on a measured luminance map of the viewing area and being configured to cause the light source to improve illumination uniformity of the viewing area.

In another aspect, the disclosure describes an apparatus for improving illumination uniformity of an illuminated area. The apparatus may comprise: at least one sensor for measuring a luminance map of the illuminated area; at least one light source for further illuminating the area in accordance with a luminance adjustment map; and at least one processor configured to compute the luminance adjustment map based on the measured luminance map.

In a further aspect, the disclosure describes a method for improving illumination uniformity of an illuminated area. The method may comprise: receiving a luminance map of the illuminated area; computing a luminance adjustment map based on the obtained luminance map; and further illuminating the illuminated area in accordance with the luminance adjustment map.

Further details of these and other aspects of the subject matter of this application will be apparent from the detailed description and drawings included below.

### DESCRIPTION OF THE DRAWINGS

Reference is now made to the accompanying drawings, in which:

FIG. 1 shows a photograph of a light booth in accordance with the prior art;

FIG. 2 shows a exemplary schematic representation of an apparatus for illuminating an area according the present disclosure;

FIG. 3 shows a photograph of an exemplary embodiment of the apparatus of FIG. 2;

FIG. 4A shows a gray-scaled photographic representation of the luminance across a viewing area having a uneven illumination;

FIG. 4B shows a gray-scaled photographic representation of a luminance adjustment map for improving illumination uniformity in the area of FIG. 4A;

FIG. 4C shows a gray-scaled photographic representation of the luminance across the viewing area of FIG. 4A further illuminated in accordance with the luminance adjustment map of FIG. 4B;

FIG. 5 shows a schematic diagram of components of the apparatus of FIG. 2 in a feedback control loop; and

FIG. 6 shows a flowchart of an exemplary method for improving illumination uniformity.

### DETAILED DESCRIPTION

Aspects of various embodiments are described through reference to the drawings.

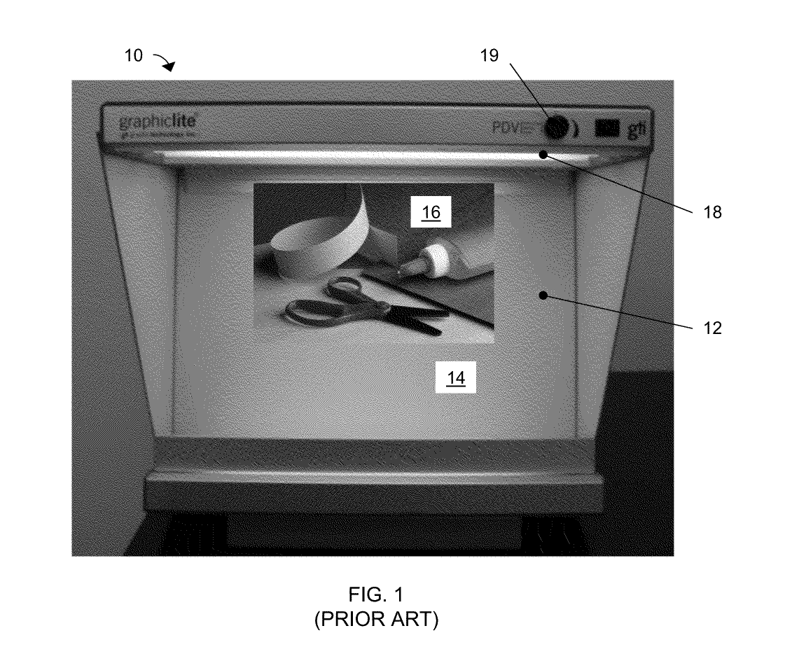

FIG. 1 shows a photograph of an exemplary light booth 10 of the type also known as an illumination station or viewing booth in accordance with the prior art. Light booth 10 may be used in conjunction with apparatus, components and methods described herein. Light booth 10 may be used for viewing suitable color reflection copy(ies) or documents such as artwork, paintings, printed posters, photographic transparencies, photographic prints, photomechanical reproductions such as on-press and off-press proofs or press sheets, textile samples, flooring samples, wood samples or any other form of hard copies for the purpose of visual color inspection, evaluation of color deviation, color-matching applications, and soft-proofing. One skilled in the relevant arts will understand that the apparatus, components and methods described herein could also be used for the illumination of other types of areas used for different applications and that are of a wide range of sizes.

Light booth 10 may include back plate(s) 12 defining viewing area(s) 14 within which hard copy(ies) 16 may be disposed for viewing, and, light source(s) 18 for illuminating viewing area(s) 14. Viewing area(s) 14 may not necessarily be a planar surface. Light source(s) 18 may be suitable positioned to illuminate viewing area(s) 14 from one or multiple directions (e.g. overhead and/or from a lower position). A suitable dimmer switch 19 (e.g. control knob) may be provided to control the output intensity of light source(s) 18. Light source(s) 18 may be dimmable and comprise one or more suitable fluorescent tube lamps such as D50 fluorescent lamps sold under the tradename GRAPHICLITE by GTI Graphic Technology, Inc. Light booth 10 may, for example, be of the type described in U.S. Patent Publication No. 2009/0034068, the entire contents of which being incorporated herein by reference. Light booth 10 may be of the type sold under the tradename GRAPHICLITE by GTI Graphic Technology, Inc. Light booth 10 may be of the type referenced in the following thesis authored by Nawar Fdhal: “Towards an Automated Soft Proofing System using High Dynamic Range Imaging and Artificial Neural Networks”, Master of Applied Science, Electrical and Computer Engineering Ryerson University, Toronto, Ontario, Canada, 2011, the entire contents of which being incorporated herein by reference.

During certain viewing activities, it may be of importance to have a relatively uniform illumination across viewing area(s) 14. Some light booths are adapted to provide a relatively uniform luminance across viewing area(s) 14 and may be configured to provide viewing conditions in accordance with International Standard ISO 3664 entitled “Graphic technology and photography—Viewing conditions”, the entire contents of which being incorporated herein by reference. However, depending on the configuration of the booth, viewing area, light sources illuminating the area and the ambient light conditions, there can still be some non-uniformities in illumination across viewing area(s) 14 that could affect some viewing activities.

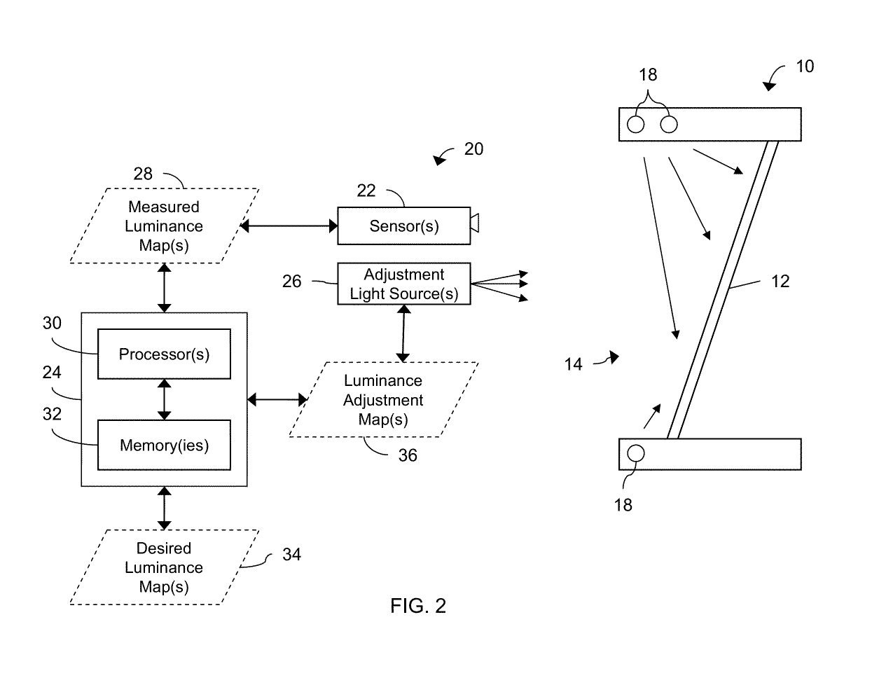

FIG. 2 shows an exemplary schematic representation of apparatus 20 that may be used for improving illumination uniformity across viewing area(s) 14. Apparatus 20 may comprise one or more sensors 22, one or more data processing devices 24 and one or more adjustment light sources 26. Data processing device(s) 24 may be configured to send or receive signal(s) to/from sensor(s) 22 and may also be configured to send or receive signal(s) to/from adjustment light source(s) 26.

Sensor(s) 22 may be configured to sense a luminance level at one or more points or regions in viewing area(s) 14. Accordingly, sensor(s) 22 may be used to measure (i.e. obtain) luminance map(s) 28 across viewing area(s) 14. Measured luminance map(s) 28 may comprise a plurality luminance levels taken at a plurality of corresponding locations on viewing area(s) 14. Sensor(s) 22 may comprise one or more digital cameras or one or more other suitable type of sensors such as a photometer or spectrometer that can generate signal(s) representative of a luminance level of a point or region in viewing area(s) 14. Sensor(s) 22 may be in communication with data processing device(s) 24 and provide signal(s) representative of luminance map(s) 28 to data processing device(s) 24. Data processing device(s) 24 may also be in communication with adjustment light source(s) 26.

Data processing device(s) 24 may comprise one or more computers having digital data processor(s) 30 and memory(ies) 32. Memory(ies) 32 may comprise any storage means (e.g. devices) suitable for retrievably storing machine-readable instructions executable by processor(s) 30. Such machine-readable instructions may cause processor(s) 30 to, based on measured luminance map(s) 28, output signal(s) useful in controlling and/or adjusting (e.g. re-configuring) adjustment light source(s) 26. For example, such machine-readable instructions may cause processor(s) 30 to detect one or more non-uniformities in measured luminance map(s) 28 and output signal(s) useful in causing adjustment light source(s) 26 to attenuate one or more of the non-uniformities. Specifically, machine-readable instructions may cause processor(s) 30 to compare measured luminance map(s) 28 to desired luminance map(s) 34 and output signal(s) representative of luminance adjustment map(s) 36 useful in causing adjustment light source(s) 26 to attenuate one or more of the non-uniformities to thereby improve illumination uniformity across viewing area(s) 14.

Adjustment light source(s) 26 may comprise any suitable light source(s) that may direct light towards viewing area(s) 14 according to luminance adjustment map(s) 36 in order to improve the uniformity of illumination across viewing area(s) 14. For example, adjustment light source(s) 26 may be adjustable (e.g. re-configurable) in order to accommodate different luminance adjustment map(s) 36. For example, adjustment light source(s) 26 may include one or more digital media projector(s) such as liquid crystal display (LCD) projectors and/or liquid crystal on silicon (LCOS) projectors for projecting one or more images on viewing area(s) 14. The one or more images projected by the projector(s) may be based on luminance adjustment map(s) 36.

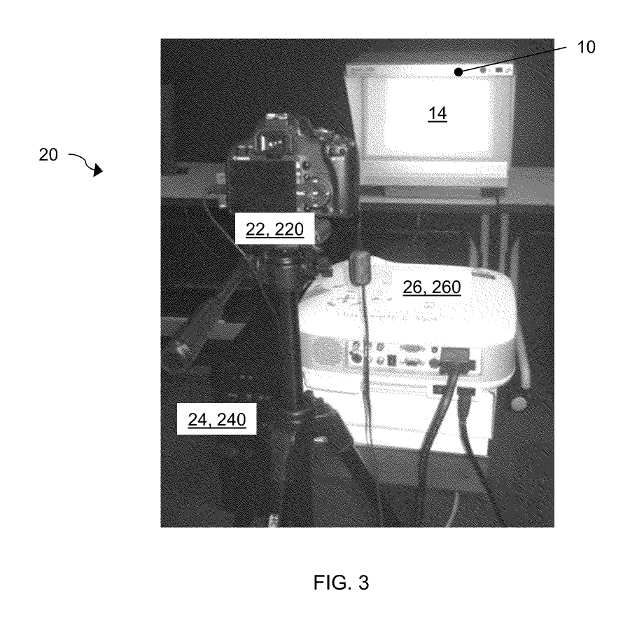

FIG. 3 shows a photograph of an exemplary embodiment of apparatus 20. As mentioned above, apparatus 20 may include one or more digital cameras 22, 220, one or more digital media projectors 26, 260 and one or more personal computers 24, 240. Computer(s) 24, 240 may be configured to receive one or more signals from digital camera(s) 22, 220 and transmit one or more signals to digital medial projector(s) 26, 260.

When using digital camera(s) 22, 220 for sensing luminance map(s) 28, it may be appropriate to capture a plurality of images (i.e. exposures) that are merged into a high dynamic range (HDR) image according to known or other methods. The plurality of images may be captured at different exposure levels. The resulting HDR image(s) may then be used to compute luminance map(s) 28.

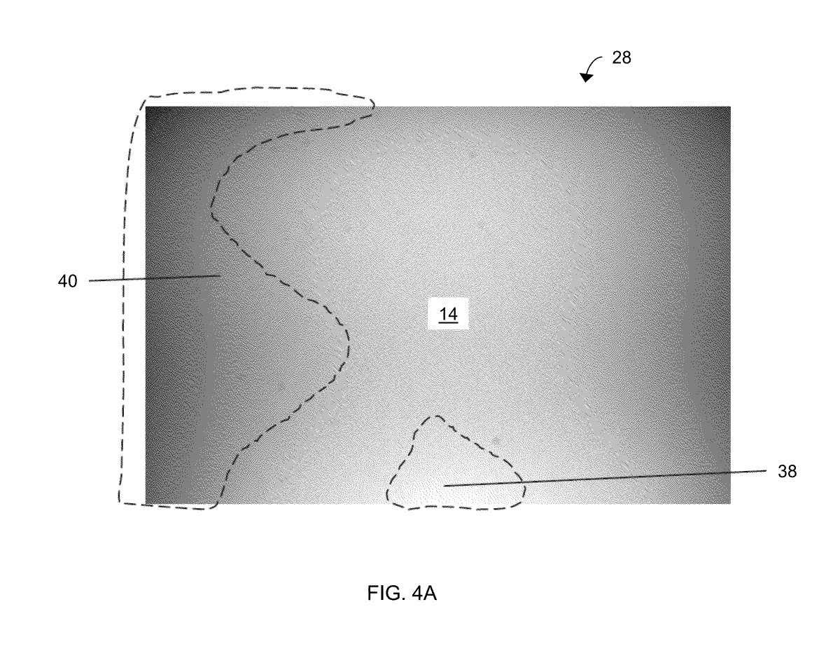

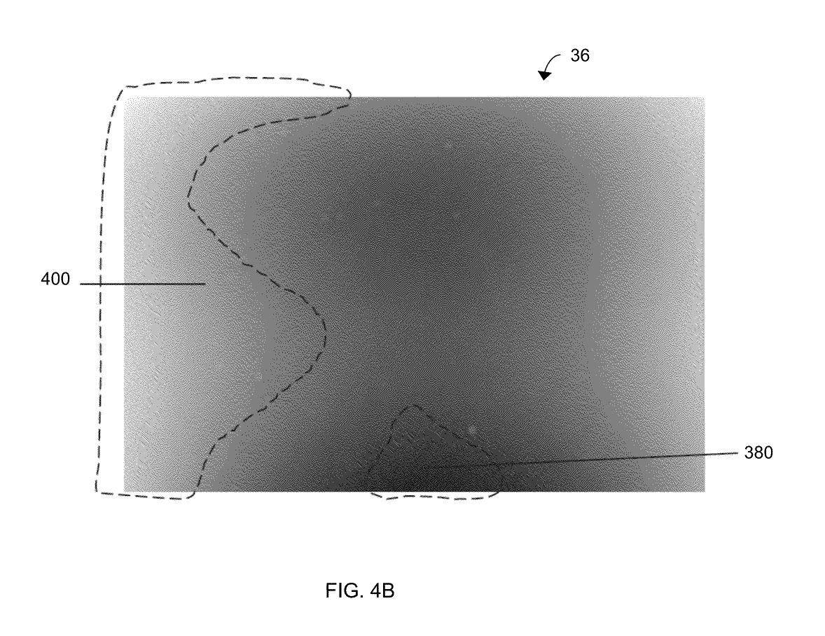

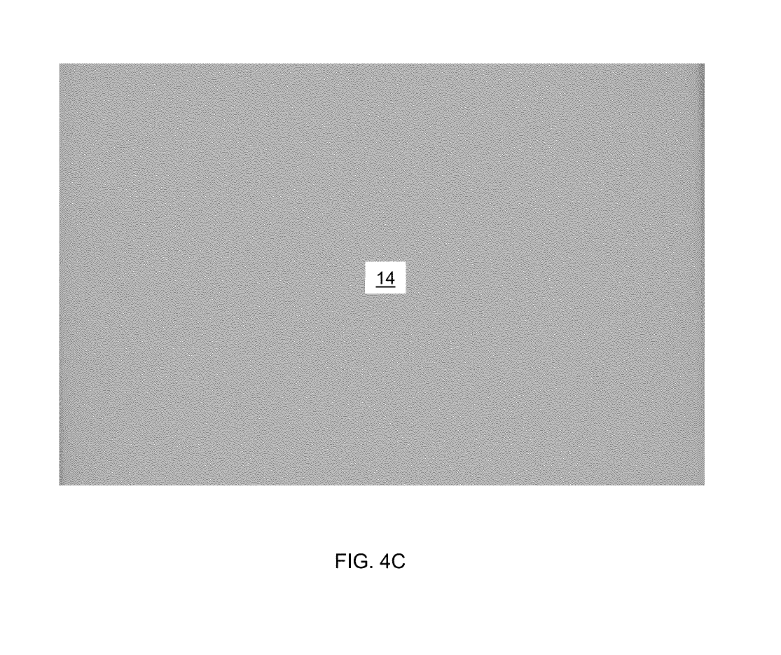

FIG. 4A shows a gray-scaled photographic representation of measured luminance map(s) 28 across area(s) 14 having an uneven illumination. Luminance map(s) 28 may be acquired with digital camera(s) 22, 220 or other suitable type of sensor(s) 22 by producing an HDR image as described above from which luminance values may be derived to produce measured luminance map(s) 28. Measured luminance map(s) 28 may comprise an array of luminance values representative of the illumination intensity of corresponding regions of viewing area(s) 14. For example, measured luminance map(s) 28 may comprise an array of numeric luminance (e.g. brightness) values associated with corresponding individual pixels or groups of pixels captured by camera(s) 22, 220. The uneven illumination in viewing area(s) 14 may result from a combination of factors including the configuration of booth 10 and any light sources (e.g. light source(s) 18, ambient light and/or any other light source(s)) that may be shedding light on viewing area(s) 14. FIG. 4A shows, for example, that viewing area(s) 14 may comprise one or more high luminance regions 38 and one or more low luminance regions 40.

FIG. 4B illustrates a photographic/visual representation of luminance adjustment map(s) 36 for use by adjustment light source(s) 26. Luminance adjustment map(s) 36 may be used as a basis to project (i.e. superimpose) an attenuation image onto viewing area(s) 14 in order to improve the uniformity of illumination of viewing area(s) 14. Luminance adjustment map(s) 36 may be determined at least in part based on measured luminance map(s) 28 and desired luminance map(s) 34. Desired luminance map(s) 34 may at least in part also be determined based on measured luminance map(s) 28 by data processing device(s) 24. For example, a high (e.g. maximum) luminance level may be selected or identified from measured luminance map(s) 28 and applied across the entirety of desired luminance map(s) 34. For example, desired luminance map(s) 34 may comprise an array of luminance values where each luminance value uniformly corresponds to the highest luminance level within measured luminance map(s) 34. Accordingly, desired luminance map(s) 34 may, for example, be representative of a uniform illumination level across viewing area(s) 14 that corresponds to the highest luminance level in viewing area(s) 14.

Depending on the type of adjustment light source(s) 26, luminance adjustment map(s) 36 may be used as a basis for generating suitable input signal(s) to adjustment light source(s) 26. For example, when using digital media projector(s) 260, 26, luminance adjustment map(s) 36 may be used as a basis for calculating corresponding red, green, blue (RBG) values compatible with digital media projector(s) 260, 26.

Luminance adjustment map(s) 36 may, for example, be determined based on a difference between measured luminance map(s) 28 and desired luminance map(s) 34. In order to compute luminance adjustment map(s) 36, measured luminance map(s) 28 may first be normalized so that a highest luminance value in measured luminance map(s) 28 may be assigned a value of one (1) and that all other (i.e. lower) luminance values in measured luminance map(s) 28 may be assigned values between zero (0) and one (1) accordingly. Luminance adjustment map(s) 36 may then be computed by subtracting all of the normalized values of the measured luminance map(s) 28 from one (1). Luminance adjustment map(s) 36 may comprise an array of luminance values intended to correspondingly bring (i.e. increase) the luminance of each region of viewing area(s) 14 to a value of one (1) corresponding to the highest luminance level in measured luminance map(s) 28. For example, luminance adjustment map(s) 36 may comprise high luminance region(s) 400 intended to increase the luminance of low luminance region 40 of measured luminance map(s) 28 and low luminance region(s) 380 intended to leave high luminance region(s) 38 of measured luminance map(s) 28 substantially unchanged. The array size of luminance adjustment map(s) 36 may be the same as or different from the array size of measured luminance map(s) 28 depending on the specific application, resolution of sensor(s) 22 and/or adjustment light source(s) 26, and, the size of viewing area(s) 14 affected.

Depending on the type of sensor(s) 22 and adjustment light source(s) 26 used, one skilled in the relevant arts will appreciate that it may be desirable that sensors(s) 22 and adjustment light source(s) 26 be registered (i.e. aligned) so that luminance values detected by sensor(s) 22 and luminance values projected by adjustment light source(s) 26 be correlated to corresponding regions of viewing area(s) 14. Registration of sensor(s) 22 and adjustment light source(s) 26 may be conducted according to known or other suitable methods.

FIG. 4C shows gray-scaled photographic representation of the luminance across the viewing area(s) 14 illuminated by adjustment light source(s) 26 in accordance with luminance adjustment map(s) 36. FIG. 4C shows that viewing area(s) 14 has an improved illumination uniformity in comparison with that of FIG. 4A. Under these lighting conditions, it may be desirable to capture a digital image of an object (e.g. hard copy(ies) 16) that is illuminated in viewing area(s) 14. For example, a digital image of hard copy(ies) 16 may be taken using camera(s) 22, 220 or any other suitable camera(s).

When acquiring measured luminance map(s) 28 using camera(s) 22, 220 with the intention of using digital media projector(s) 26, 260 as an adjustment light source, it may be desirable to at least temporarily cover viewing area(s) 14 with a material having substantially uniform reflectivity and then project a substantially uniform black image on viewing area(s) 14 before acquiring measured luminance map(s) 28. For example, viewing area(s) 14 may be covered with a white or gray paper having a matte finish to provide a surface having a substantially uniform and relatively low reflectivity. The projection of a substantially uniform black image on viewing area(s) 14 may permit the “black offset” of projector(s) 26, 260 to be taken into consideration since the amount of light projected by projector(s) 26, 260 for black may not be exactly zero and therefore may contribute to the illumination of viewing area(s) 14.

Adjustment light source(s) 26 may be configured to output light that is compatible with the viewing conditions desired at viewing area(s) 14. In some instances, projector(s) 26, 260 may comprise a standard red, green and blue color space (sRGB) output setting in accordance with standards promulgated by the International Color Consortium (ICC) that may cause projector(s) 26, 260 to output D50 light compatible with some viewing conditions and which may appropriately blend with light emitted by light source(s) 18. It is understood that projector(s) 26, 260 could be configured to output light of different color temperatures such as 5000 k to match D50 lighting.

One skilled in the relevant arts will understand that multiple adjustment light source(s) 26 may be used depending on, for example, the size of viewing area(s) 14 and the level of luminance required to achieve the level of illumination uniformity desired. For example, it may be appropriate to have multiple adjustment light sources 26 covering different regions of relatively large viewing area(s) 14 and/or have multiple adjustment light sources 26 covering the same region of viewing area(s) 14 in order to achieve a relatively high luminance level. It may also be appropriate in some instances to defocus adjustment light source(s) 26 by some amount in order to promote blending of the attenuating light with the existing light already illuminating viewing area(s) 14. The defocusing of adjustment light source(s) 26 may cause individual pixel variations to become less prominent. It may also be appropriate in some instances to have sensor(s) 22 and adjustment light source(s) 26 at different positions and not necessarily perpendicular to viewing area(s) 14.

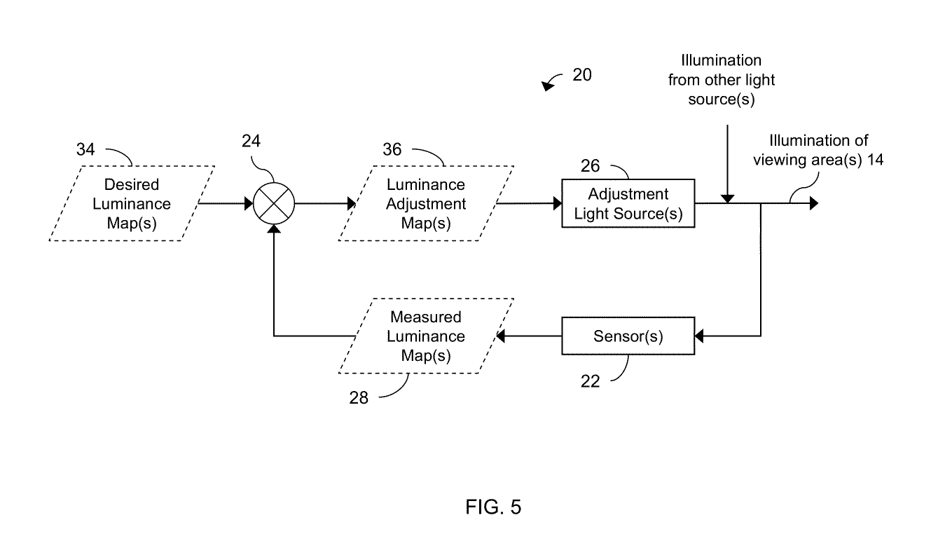

FIG. 5 illustrates an exemplary embodiment of sensor(s) 22, data processing device(s) 24 and adjustment light source(s) 26 being part of a feedback control loop to provide dynamic adjustment of the illumination of viewing area(s) 14 to continuously provide improved illumination uniformity. Data processing device(s) 24 is shown as a summing junction that produces luminance adjustment maps(s) 36 based on measured luminance map(s) 28 and desired luminance map(s) 34. As shown, viewing area(s) 14 may be illuminated by adjustment light source(s) and additionally by other light sources such as light source(s) 18 or other ambient lights that may vary depending on the environment. For example, ambient lighting conditions that depend on sunlight/cloud cover and that could vary could be considered disturbances to the illumination of viewing area(s) 14 and taken into consideration in the dynamic adjustment of adjustment light source(s) 26.

Alternatively, one skilled in the relevant arts will understand that luminance adjustment map(s) 36 could be generated once for a particular configuration of light booth 10 or viewing area(s) 14 and then adjustment light source(s) 26 could be selected or configured based of such initial luminance adjustment map(s) 36 and subsequently reused (e.g. permanently). During such subsequent reuse, the use of sensor(s) 22 and data processing device(s) 24 (depending on the type of adjustment light source(s) 26) may not be required.

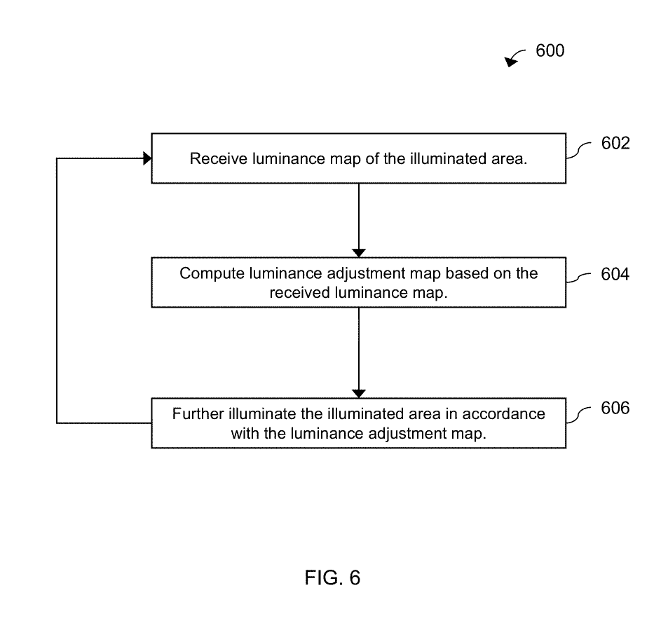

FIG. 6 shows a flowchart illustrating an exemplary method 600 that may be used to improve illumination uniformity of viewing area(s) 14, which may already be illuminated by some other light sources such as light source(s) 18. Method 600 may be conducted using apparatus 20 and components described herein. Method 600 may be executed based at least in part on the machine-readable instructions stored in memory(ies) 32 for execution by processor(s) 30 (see FIG. 2). For example, method 600 may comprise: receiving luminance map(s) 28 of illuminated viewing area(s) 14 (see block 602); computing luminance adjustment map(s) 36 based on received luminance map(s) 28 (see block 604); and further illuminating the illuminated viewing area(s) 14 in accordance with luminance adjustment map(s) 36 (see block 606).

As mentioned above, luminance adjustment map(s) 36 may be configured to cause attenuation of illumination non-uniformity in illuminated viewing area(s) 14 and thereby improve illumination uniformity. For example, luminance adjustment map(s) 36 may be configured to cause an increase of the luminance of low luminance region(s) 40 of viewing area(s) 14. Desired luminance map(s) 36 may be configured to cause an increase of the luminance of low luminance region(s) 40 of illuminated viewing area(s) 14 to that of high luminance region(s) 38 of illuminated area(s) 14. For example, luminance adjustment map(s) 36 may be based on a difference between desired luminance map(s) 34 and received/measured luminance map(s) 28. Desired luminance map(s) 34 may have a uniform luminance value equivalent to a highest luminance value in received/measured luminance map(s) 28.

The above description is meant to be exemplary only, and one skilled in the relevant arts will recognize that changes may be made to the embodiments described without departing from the scope of the invention disclosed. The blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified. The present disclosure may be embodied in other specific forms without departing from the subject matter of the claims. Also, one skilled in the relevant arts will appreciate that while the apparatus, components and methods disclosed and shown herein may comprise a specific number of elements/components, the apparatus, components and methods could be modified to include additional or fewer of such elements/components. For example, while any of the elements/components disclosed may be referenced as being singular, it is understood that the embodiments disclosed herein could be modified to include a plurality of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

What is claimed is:

1. An apparatus for viewing a hard copy, the apparatus comprising:
a viewing area for receiving the hard copy;
a light source configured to illuminate the viewing area in accordance with a luminance adjustment map, the luminance adjustment map being based on a measured luminance map of the viewing area and being configured to cause the light source to improve illumination uniformity of the viewing area.

2. The apparatus as defined in claim 1, wherein the luminance adjustment map is based on a difference between a desired luminance map and a measured luminance map.

3. The apparatus as defined in claim 2, wherein the desired luminance map has a uniform luminance value representative of a high luminance value in the measured luminance map.

4. The apparatus as defined in claim 1, wherein the light source comprises a digital media projector.

5. The apparatus as defined in claim 1, comprising a sensor for generating at least one signal representative of the measured luminance map.

6. The apparatus as defined in claim 1, comprising a processor for receiving at least one signal representative of the measured luminance map and generating at least one signal representative of the luminance adjustment map.

7. The apparatus as defined in claim 1, comprising:
a sensor configured to generate at least one signal representative of the measured luminance map; and
a processor configured to receive the signal representative of the measured luminance map and generate at least one signal representative of the luminance adjustment map.

8. The apparatus as defined in claim 7, wherein the luminance adjustment map is based on a difference between a desired luminance map and a measured luminance map.

9. The apparatus as defined in claim 7, wherein the sensor, the processor and the light source are in a feedback control loop.

10. An apparatus for improving illumination uniformity of an illuminated area, the apparatus comprising:
at least one sensor for measuring a luminance map of the illuminated area;
at least one light source for further illuminating the area in accordance with a luminance adjustment map; and
at least one processor configured to compute the luminance adjustment map based on the measured luminance map.

11. The apparatus as defined in claim 10, wherein the luminance adjustment map is based on a difference between a desired luminance map and the measured luminance map.

12. The apparatus as defined in claim 11, wherein the desired luminance map has a uniform luminance value equivalent to a high luminance value in the measured luminance map.

13. The apparatus as defined in claim 10, wherein the luminance adjustment map is configured to cause the at least one light source to increase the luminance of a low luminance region of the illuminated area.

14. The apparatus as defined in claim 10, wherein the sensor, the processor and the light source are included in a feedback control loop.

15. The apparatus as defined in claim 10, wherein the light source is re-configurable based on the luminance adjustment map.

16. A method for improving illumination uniformity of an illuminated area, the method comprising:
receiving a luminance map of the illuminated area;
computing a luminance adjustment map based on the obtained luminance map; and
further illuminating the illuminated area in accordance with the luminance adjustment map.

17. The method as defined in claim 16, wherein the luminance adjustment map is configured to cause an increase of the luminance of a low luminance region of the area.

18. The method as defined in claim 16, wherein the desired luminance map is configured to cause an increase of the luminance of a low luminance region of the illuminated area to that of a high luminance region of the illuminated area.

19. The method as defined in claim 16, wherein the luminance adjustment map is based on a difference between a desired luminance map and the received luminance map.

20. The method as defined in claim 19, wherein the desired luminance map has a uniform luminance value equivalent to the highest luminance value in the received luminance map.
